(19) United States
(12) Patent Application Publication
(10) Pub. No.: US 2002/0045543 A1
(43) Pub. Date: Apr. 18, 2002

(54) Alumina particles with dispersed noble metal, process for producing the same and exhaust gas purifying catalyst employing the same

(75) Inventors: Kazumasa Takatori, Aichi (JP); Takao Tani, Aichi (JP); Nobuo Kamiya, Aichi (JP); Oji Kuno, Susono-shi (JP); Shinji Tsuji, Numazu-shi (JP); Masahiko Sugiyama, Mishima-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toyota Chuo Kenkyusho, Aichi-ken (JP)

(21) Appl. No.: 09/935,664

(22) Filed: Aug. 24, 2001

(30) Foreign Application Priority Data
Aug. 24, 2000 (JP) 2000-253993

(51) Int. Cl. B01J 23/38

(52) U.S. Cl. 502/302; 502/341; 502/304; 502/303; 502/334; 502/333; 502/332

(57) ABSTRACT

Disclosed are alumina particles with a dispersed noble metal. The alumina particles are hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method. The noble metal dispersion degree is so high that the alumina particles are suitable for making a catalyst. The resulting catalyst exhibits the purifying performance, which hardly differs before and after a high temperature durability test, and is extremely good in terms of the durability.

### BACKGROUND OF THE INVENTION

1. Field of the Invention

The present invention relates to alumina particles with a dispersed noble metal, which are useful as a catalyst for purifying an automotive exhaust gas, and a process for producing the same.

2. Description of the Related Art

As a catalyst for purifying an automotive exhaust gas, a catalyst has been used widely in which a noble metal, such as platinum (Pt), rhodium (Rh), palladium (Pd), or the like, is loaded on a support, such as alumina (Al₂O₃), or the like. In particular, since a support, which is composed of a γ-Al₂O₃ powder, exhibits a large specific surface area, the exhaust gas diffuses into the pores so that the catalytic reactions become active on the surface of the noble metal particles, which are loaded on the support in a highly dispersed manner. Accordingly, the γ-Al₂O₃ powder has been used widely as a support for the catalyst.

In such a catalyst, however, there arose a case where the noble metal grew granularly and solved in the support in a high temperature durability test. If such is the case, the catalytic active sites may decrease and the purifying activities lower after the high temperature durability test.

Hence, in Japanese Unexamined Patent Publication (KOKAI) N. 10-328,566, there is disclosed a catalyst. In the catalyst, Rh is loaded on a support, in which θ-Al₂O₃, exhibiting a specific surface area of 50 m²/g or more, is a major component. Since θ-Al₂O₃ is superior to γ-Al₂O₃ in terms of the stability at elevated temperatures, Rh is less likely to solve in the support. Moreover, the sintering of Rh, which is accompanied by the phase transformation of Al₂O₃ or its own grain growth, is suppressed. Thus, it is believed that the activities of Rh can be maintained sufficiently during a high temperature durability test. Hence, the catalyst is good in terms of the durability.

However, in the catalyst in which Rh is loaded on the support whose major component is the θ-Al₂O, exhibiting a specific surface area of 50 m²/g or more, although the solving of Rh in the Al₂O₃ can be inhibited compared with the case where Rh is loaded on γ-Al₂O₃, it is inevitable that the Rh is solved in the Al₂O₃ to a certain extent. Then, once the Rh is solved in the Al₂O₃, it is difficult for the Rh to re-precipitate. Consequently, there may arise a drawback in that the purifying activities of Rh degrade gradually as time elapses.

In Japanese Unexamined Patent Publication (KOKAI) No. 11-314,035, the applicants of the present invention disclose a support which comprises a composite oxide powder. The composite oxide powder is formed by spraying and burning a W/O type emulsion, in which an aqueous solution, comprising aluminum as a major component and at least one auxiliary metallic element, is dispersed in an organic solvent.

The composite oxide powder comprises porous hollow particles whose shell thickness is very thin as small as several dozens of nm, and exhibits a specific surface area of 50 m²/g or more even when its particle diameter is hundreds of nm or more. Accordingly, despite the specific surface area, it has advantages in that it has a large particle diameter and it is less likely to undergo grain grow. Therefore, in a catalyst which is made by loading a noble metal on this support, the grain growth of the noble metal is suppressed so that the catalyst is good in terms of the durability.

However, even in the catalyst which is made by loading a noble metal on the support being composed of the hollow particles, it is not possible to avoid the grain growth, which is caused by the moving noble metal on the support. Consequently, the durability of the catalyst is degraded to that extent. Hence, in Japanese Unexamined Patent Publication (KOKAI) No. 11-314,035, there is further disclosed another catalyst. The catalyst comprises another composite oxide powder, which is formed by spraying and burning a W/O type emulsion, in which an aqueous solution, comprising aluminum as a major component and a noble metal, is dispersed in an organic solvent.

In accordance with the catalyst, the noble metal particles exists in the hollow particles in a highly dispersed manner, and are inhibited from moving. Hence, the grain growth of the noble metal is controlled so that the catalyst is good in terms of the durability.

In the catalyst disclosed in Japanese Unexamined Patent Publication (KOKAI) No. 11-314,035, while the shell thickness of the hollow particles is several dozens of nm, the noble metal particles have a particle diameter of about 2 nm or less, and are dispersed in the shells of the hollow particles in a highly dispersed manner. Accordingly, the degree of the noble metal particles, which are exposed in the surfaces of the hollow particles, is small with respect to the total volume of the included noble metal particles. On the other hand, the degree of the portions of the noble metal particles, which are buried in the shells of the hollow particles, is large with respect to the total volume of the included noble metal particles. In fact, the dispersion degree of the noble metal, which is measured by the CO adsorption method, is so small that it falls in a range of from 3 to 5%. Thus, it has been apparent that the rate of the exposed novel metal is small. Note that the dispersion degree of the noble metal, being referred to in this specification of the present invention, is a value calculated by the following equation.

The Dispersion Degree of the Noble metal (%)=100×{(Amount of Noble metal Equivalent to CO Adsorption Amount (mol))/(Total Amount of Included Noble metal)}

The catalytic reactions occur on the surface of the exposed noble metal. Accordingly, in the aforementioned catalyst, it is difficult to effectively utilize the portions of the noble metal particles, which are buried in the shells of the hollow particles. Thus, there may arise a drawback in that it is not possible to obtain the purifying performance, which would be expected from the total amount of the included noble metal.

### SUMMARY OF THE INVENTION

The present invention has been developed in view of such circumstances. It is therefore an object of the present invention to effectively utilize the included noble metal in the catalyst, which is formed of the support being composed of hollow particles like those disclosed in Japanese Unexamined Patent Publication (KOKAI) No. 11-314,035.

Alumina particles with a dispersed noble metal according to the present invention can solve the aforementioned problems, and are characterized in that the alumina particles are hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method.

It is desired that the present alumina particles with a dispersed noble metal can further comprise at least one member selected from the group consisting of rare-earth elements and alkaline-earth metal elements.

Then, a process according to the present invention for producing the present alumina particles with a dispersed noble metal is characterized in that it comprises the steps of: preparing a W/O type emulsion, which is formed by dispersing an aqueous solution in an organic solvent, the aqueous solution comprising aluminum element as a major component and at least one noble metal; spraying and burning the W/O type emulsion, thereby forming hollow particles; and heat-treating the hollow particles in a non-oxidizing atmosphere at a temperature of from 950° C. or more to 1,050° C. or less, thereby preparing alumina particles being hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method. It is not preferable to carry out the heat treatment at a temperature of less than 950° C., because the amorphous phase does not turn into the γ-phase Al₂O₃. On the other hand, it is not preferable to carry out the heat treatment at a temperature of more than 1,050° C., because the amorphous phase undergoes the phase transformation into the α-phase Al₂O₃ so that the hollow structure cannot be sustained.

Moreover, an exhaust gas purifying catalyst according to the present invention is characterized in that it comprises: alumina particles with a dispersed noble metal, the alumina particles being hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method.

In the present exhaust gas purifying catalyst, it is desired the present alumina particles with a dispersed noble metal can further comprise at least one member selected from the group consisting of rare-earth elements and alkaline-earth metal elements.

For instance, in accordance with the present invention, the dispersion degree of the noble metal is high in the present alumina particles with a dispersed noble metal. Accordingly, the present alumina particles with a dispersed noble metal are suitable for a catalyst. Moreover, the present catalyst employing the present alumina particles with a noble metal dispersed exhibits the purifying performance, which hardly differs before and after a high temperature durability test, and is extremely good in terms of the durability accordingly.

### DETAILED DESCRIPTION OF THE PREFERRED EMBODIMENTS

Having generally described the present invention, a further understanding can be obtained by reference to the specific preferred embodiments which are provided herein for the purposes of illustration only and not intended to limit the scope of the appended claims.

In general, the smaller the particle diameter of an oxide powder is, the higher the oxide powder exhibits activities. An Al₂O₃ powder, which is produced by the conventional wet-type production process, has such a small primary particle diameter that it is as small as several dozens of nm or less, and accordingly exhibits very high activities. Hence, even in a case where at least one member selected from the group consisting of rare-earth elements and alkaline-earth metal elements is added to the Al₂O₃ powder, the phase transformation into the α-phase occurs when it is subjected to a high temperature of about 1,000° C. Consequently, the specific surface area of the Al₂O₃ powder lowers considerably. While, when the primary particle diameter is several hundreds of nm, the reactivities of the Al₂O₃ powder are so low that the transformation into the α-phase of the Al₂O₃ powder is suppressed. On the contrary, in particles which have a large primary particle diameter, since the original specific surface area is as small as a couple of m²/g or less, it is not appropriate to employ them as a catalyst support. Note that the term, “primary particles”, herein means particles that are not agglomerated.

Hence, the alumina particles with a dispersed noble metal according to the present invention are constituted by hollow-structured alumina particles, which comprise alumina as a major component of the matrix, and in which at least one noble metal is dispersed in the alumina matrix and/or on the surface of the alumina particles. By making the present alumina particles the hollow particles, it is possible to simultaneously coexist large primary particles and large specific surface areas. Thus, the present alumina particles with a dispersed noble metal are suitable for a catalyst support. Note that the term, “hollow”, herein means that particles have an inner space. It is desired that the shell between the inner space and the outer space can have an opening. The number of the inner spaces is not limited in particular. However, it is preferable to employ a porous substance, in which the inner space occupies a large volume. Here, in this specification of the present invention, the aforementioned shell is referred to as the matrix.

In the alumina particles with a dispersed noble metal, the specific surface area is inversely proportional to the shell thickness substantially. When the shell thickness is too large, the specific surface area diminishes. Accordingly, the thickness of the shell can desirably be 100 nm or less, further desirably be 50 nm or less, and furthermore desirably be 20 nm or less. When the shell thickness is made 100 nm or less, it is possible to secure a preferable specific surface area for a catalyst support.

In the alumina particles with a dispersed noble metal according to the present invention, the outside diameter can preferably fall in a range of from 50 nm to 5 μm. A ratio of the inside diameter with respect to the outside diameter can preferably fall in a range of from 0.5 to 0.99. With such arrangements, it is possible to make the thickness of the shell extremely thin, and to suppress the degradation of the catalytic performance, which is caused by the noble metal solving in the alumina. Accordingly, the degradation of the purifying activities after a durability test can be further suppressed. When the outside diameter is less than 50 nm, there exists no hollow portion. In accordance with the present production process, it is difficult to produce hollow particles, which have an outside diameter of more than 5 μm. Moreover, the present alumina particles with a dispersed noble metal have pores whose pore diameter falls in a range of from 10 to 2,000 nm. It is believed that such pores contribute to the gas diffusion effectively.

The matrix of the alumina particles with a dispersed noble metal can comprise alumina alone. In addition to the alumina, they can further comprise at least one oxide or composite oxide, which is composed of at least one member selected from the group consisting of titania, zirconia, etc. It is especially desired, however, that the alumina is a major component. Moreover, the present alumina particles with a dispersed noble metal can desirably have a specific surface area of 30 m²/g or more. When the specific surface area is less than 30 m²/g, there may unpreferably arise a case where they exhibit insufficient performance as a catalyst.

In addition, it is desired that the alumina, constituting the shell of the hollow particles, can have a crystalline grain boundary in at least a part thereof and can be crystallized therein. With such arrangements, it is possible to heighten the probability of the existence of the noble metal fine particles in the grain boundary. The noble metal fine particles in such a shell are less likely to sinter than the noble metal particles in the surface of the shell. Thus, it is possible to suppress the grain growth of the noble metal. The fine particle-shaped noble metal is exposed gradually, and thereby it is possible to further improve the durability of the catalytic performance.

The present alumina particles with a dispersed noble metal hardly vary the specific surface area, and keeps the amorphous structure substantially when it is subjected to a temperature of 1,100° C. or less. This phenomenon is closely related to the arrangement that they are formed as the hollow particles. For example, when one tries to obtain a powder, which is formed as a solid particles having a specific surface area of 50 m²/g or more and comprising Al₂O₃ as a major component, it is required that the primary particle diameter be about 30 nm or less. In general, since small particles exhibit high activities, they are likely to undergo grain growth at elevated temperatures. On the contrary, since the present alumina particles with a dispersed noble metal can be formed as a hollow particles whose shell has a very thin thickness, they can have a large specific surface area of 50 m²/g or more when they have a particle diameter of several hundreds of nm or more. Thus, the present alumina particles with a dispersed noble metal have a large specific surface area, and simultaneously have a large particle diameter. Consequently, the present alumina particles with a dispersed noble have an advantage in that they are less likely to undergo grain growth.

The present alumina particles with a dispersed noble metal can preferably be constituted by Al₂O₃, in which at least one member selected from the group consisting of rare-earth elements and alkaline-earth metal elements is included in an amount of from 1 to 10% by mol with respect to the alumina, in order to further enhance the durability. Since the γ-phase of the alumina is stabilized by the addition of at least one member selected from the group consisting of rare-earth elements and alkaline-earth metal elements, it is possible to suppress the lowering of the specific surface area at a high temperature. Thus, the hollow structure is maintained after the present alumina particles with a dispersed noble metal are subjected to a high temperature. Hence, the fine noble metal, disposed in the shell, is exposed gradually in the surface of the hollow particles. All in all, in the present alumina particles with a noble metal dispersed, the degrading extent of the purifying performance is remarkably small after a heat resistance test. Note that, when at least one member selected from the group consisting of rare-earth elements and alkaline-earth metal elements is added to Al₂O₃, the heat treatment temperature can preferably fall in a range of from 950 to 1,200° C. in the heat-treating step. It is not preferable to carry out the heat treatment at a temperature of less than 950° C., because the amorphous phase does not turn into the γ-phase Al₂O₃. On the other hand, it is not preferable to carry out the heat treatment at a temperature of more than 1,200° C., because the amorphous phase undergoes the phase transformation into the α-phase Al₂O₃ so that the hollow structure cannot be sustained.

In the alumina particles with a dispersed noble metal according to the present invention, the content of at least one member selected from the group consisting of rare-earth elements and alkaline-earth metal elements can preferably fall in a range of from 1 to 8% by mol with respect to the alumina, and can especially desirably fall in a range of from 2 to 6% by mol with respect to the alumina. When the content of at least one member selected from the group consisting of rare-earth elements and alkaline-earth metal elements is less than 1% by mol, it is difficult to stabilize the γ-phase of Al₂O₃ and accordingly it is difficult to inhibit the specific surface of Al₂O₃ from diminishing at elevated temperatures. On the other hand, when the content of at least one member selected from the group consisting of rare-earth elements and alkaline-earth metal elements is more than 8% by mol, stable compounds, such as aluminates, like LaAlO₃, etc., are generated upon the application of elevated temperatures so that the specific surface area of Al₂O₃ diminishes.

As for the rare-earth elements, it is possible to exemplify La, Ce, Yb, Nd and Sm. It is possible to use one of them or a plurality of them. Among them, La is especially desirable. By solving a rare-earth element oxide in Al₂O₃, the alumina particles with a dispersed noble metal according to the present invention can particularly be improved in terms of the heat resistance.

As for the alkaline-earth metal elements, Ba or Mg is especially desirable. By solving an alkaline-earth metal oxide in Al₂O₃, the alumina particles with a dispersed noble metal according to the present invention can particularly be improved in terms of the heat resistance.

As for the noble metal, which is included in the alumina particles with a dispersed noble metal according to the present invention, it is possible to use at least one member selected from the group consisting of Pt, Rh, Pd, Ir, Ru, etc. Among them, Pt is more desirable, because it exhibits high catalytic activities.

The content of the noble metal can preferably fall in a range of from 0.1 to 5% by mass with respect to the matrix in which alumina is a major component. When the content of the noble metal is less than the lower limit, the amount of the noble metal, which is exposed in the surface of the hollow alumina particles, is remarkably less so that the resulting alumina particles with a noble dispersed exhibit low catalytic activities. On the other hand, when the noble metal is contained in an amount exceeding the upper limit, the resulting alumina particles with a dispersed noble metal become expensive unpreferably.

Then, the alumina particles with a dispersed noble metal according the present invention exhibit a noble metal dispersion degree of 10% or more when it is measured by the CO adsorption method. Therefore, the noble metal is exposed in the surface of the shell with such a high rate that the present alumina particles with a dispersed noble metal exhibit high activities. Although the upper limit of the noble metal dispersion degree is not limited in particular, the upper limit is assumed to be about 45% by the experiments carried out so far. It is presumed, however, that the catalytic performance of the present alumina particles with a dispersed noble metal would not be degraded even if the noble metal dispersion degree would be 45% or more.

In addition, the hollow particles, in which alumina is a major component of the matrix, is stable up to 1,100° C. as set forth above. Since the structural change occurs gradually in the hollow particles, the fine noble metal particles, which have been enclosed in the oxide, diffuse gradually onto the surface of the hollow particles. Accordingly, the present alumina particles with a dispersed noble metal keep a high durability even after it is subjected to a high temperature durability test.

In a process according to the present invention for producing the above-described present alumina particles with a dispersed noble metal, a W/O type emulsion is first prepared by dispersing an aqueous solution in an organic solvent. The aqueous solution comprises alumina as a major component and at least one noble metal element. Then, the W/O type emulsion is sprayed and burned. Thus, the present alumina particles with a dispersed noble metal are produced.

In the spraying and burning, a diameter of the dispersed water droplets (e.g., from a couple of nm to a couple of μm) is a reaction field. Namely, in the sprayed mist, the dispersed particles, which are contained in the emulsion, become atomized particles. The atomized particles are composed of a water phase, which is covered with an oil film. The oil film is composed of the organic solvent. Once the atomized particles are ignited, the combustion of the oil films is induced. The atomized particles are exposed to a high temperature by the generating heat. Then, the metallic elements, which are contained in the water phase inside the atomized particles, are oxidized so that an oxide powder is generated. Since the atomized particles are fine, it is possible to suppress the arising of the temperature distributions between the respective atomized particles. Thus, it is possible to prepare a homogeneous composite oxide powder. Moreover, it is possible to produce an amorphous composite oxide powder with ease.

In addition, since the dispersion particles of the W/O type emulsion are composed of Al elements as a major component, porous hollow particles, whose shell thickness is very thin as small as dozens of nm, are formed by the spraying and burning. At present, the cause is not still clear. However, it is assumed as hereinafter described. Since the rate of the superficial oxide film formation is large in the Al ions; a superficial oxide film is formed on the surface of the particles at a stage where the particles contract less. As a result, the dispersion particles become the porous hollow substances whose shell thickness is extremely small.

In the spraying and burning of the W/O type emulsion, the diameter of the respective dispersion water droplets becomes a reaction field as set described above. However, when the diameter of the dispersion water droplets is less than 100 nm, the dispersion particles contract completely before the formation of the superficial oxide film so that they do not become hollow. Hence, such a small diameter is not preferable. On the other hand, when the diameter of the dispersion water droplets is more than 10 μm, there is a possibility in that the reaction field becomes so large that the resulting particles become inhomogeneous. Hence, such a large diameter is not preferable, either. When the diameter of the dispersion water droplets in the emulsion falls in a range of from 100 nm to 10 μm, the outside diameter of the produced hollow particles falls in a range of from 50 nm to 5 μm.

In the spraying and burning, the burning temperature can desirably be 1,000° C. or less, and can further desirably fall in a range of from 700 to 900° C. When the burning temperature exceeds 900° C., a part of the resulting products undergo grain growth to become a crystalline powder. The specific surface area of the resulting particles diminishes, and at the same time the noble metal undergoes grain growth by heat. Hence, there may arise a case where the activities of the resulting particles degrade. When the burning temperature is too low, the organic components are not burned completely. Hence, there may arise a fear of the remaining carbonaceous components. Moreover, in the dispersion water droplets in the W/o type emulsion, the metallic concentration can desirably fall in a range of from 0.2 to 2.4 mol/L by metallic conversion. When the concentration is lower than the lower limit, the resulting particles are less likely to be hollow. In addition, in view of solubility, it is difficult to make the metallic concentration higher than the upper limit.

In the dispersion water droplets in the W/O type emulsion, the Al elements are a major component. In addition to the Al elements, the elements of at least one noble metal are included therein. Depending on specific cases, a rare-earth element, such as La, etc., or an alkaline-earth metal element, such as Ba, etc., can be included therein. In order to include these metallic elements in the water phase, water-soluble metallic salts, such as metallic nitrates, metallic acetates, metallic sulfates, metallic chlorides, metallic complex salts, or the like, can be solved in water. Then, the W/O type emulsion can be formed by stirring an aqueous solution of metallic salts, an organic solvent and a dispersion agent. As for the organic solvent to be used, it can be an organic solvent, such as hexane, octane, kerosine, gasoline, or the like, which can form the W/O type emulsion together with an aqueous solution. The species and addition amount of the dispersion agent are not limited in particular. The dispersion agent can be either one of cationic surface-active agents, anionic surface-active agents, and nonionic surface-active agents. Depending on the species of the aqueous solution and organic solvent as well as the diameter of the dispersion particles in the required W/O type emulsion, the species and addition amount of the dispersion agent can be varied freely.

The content of the noble metal element can desirably fall in a range of from 0.1 to 5% by mass with respect to the resulting matrix in which alumina is a major component. When the content is less than the lower limit of the range, it is difficult to make the dispersion degree of the noble metal, which is measured by the Co adsorption method, 10% or more.

The atmosphere, in which the W/O type emulsion is sprayed and burned, is not limited in particular. However, when oxygen is not present sufficiently, there may arise a fear of residing carbonaceous components, which have been contained in the organic solvent, in the resulting particles by incomplete combustion. Accordingly, it is desirable to supply oxygen (or air) in such an amount that the organic solvent, which is contained in the W/O type emulsion, can be combusted completely.

In the alumina particles with a dispersed noble metal, which are obtained by the spraying and burning, a weak peak of the γ-Al₂O₃ phase, in which an amorphous phase is a major component, can be identified by the X-ray diffraction pattern. In this state, in a case where the W/O type emulsion includes the noble metal in an amount of 0.5% by mass, the resultant alumina particles exhibit a noble metal dispersion degree of from 3 to 5% when it is measured by the CO adsorption method. The noble metal dispersion degree depends on the content of the included noble metal. Therefore, in the production process according to the present invention, the alumina particles with a dispersed noble metal, which are prepared in the aforementioned manner, are further subjected to a heat treatment, which is carried out in a non-oxidizing atmosphere at a temperature of from 950° C. or more to 1,200° C. or less. With the heat treatment, it is possible to make the noble metal dispersion degree 10% or more when it is measured by the CO adsorption method. It is believed that this phenomenon takes place in the following manner. The amorphous phase is crystallized into the γ-Al₂O₃ phase, or the θ-Al₂O₃ phase is generated partially, and thereby the fine noble metal particles, which have been buried in the amorphous Al₂O₃ phase, are exposed in the surface of the alumina particles with a dispersed noble metal. Moreover, the heat treatment heightens the probability of the existence of the noble metal particles in the crystalline grain boundaries. Such noble metal particles gradually diffuse in the surface of the hollow particles when they are heated at a high temperature. Thus, it is possible to suppress the degradation of the catalytic activities of the present alumina particles with a dispersed noble metal.

The heat treatment is carried out in a non-oxidizing atmosphere. This is because the noble metal particles are sintered so that they are likely to undergo grain growth when the heat treatment is carried out in an oxidizing atmosphere. As for the non-oxidizing atmosphere, it is possible to utilize a reducing atmosphere, an inert gas atmosphere, and the like. In a certain case, it is possible to carry out the heat treatment in an exhaust gas, which is a reducing-component-rich atmosphere.

The temperature of the heat treatment is adjusted so as to fall in the range of from 950 to 1,200° C. When the temperature of the heat treatment is less than 950° C., it is difficult to make the noble metal dispersion degree 10% or more when it is measured by the CO adsorption method. When the temperature of the heat treatment is more than 1,200° C, there may arise a case where the noble metal is sintered to undergo grain growth. While, when at least one member selected from the group consisting of rare-earth elements and alkaline-earth metal elements is not added to Al₂O₃, the heat treatment temperature can preferably fall in a range of from 950 to 1,050° C. for the same reason as aforementioned. Moreover, the time for the heat treatment depends on the temperature of the heat treatment. It is desirable, however, to fall in a range of from 0.1 to 10 hours.

The exhaust gas purifying catalyst according to the present invention comprises the hollow alumina particles with a dispersed noble metal, which are produced by the above-described process. It can be used in a simple state, in which a powder includes the present alumina particles with a dispersed noble metal only, or in a mixed state, in which the present alumina particles with a dispersed noble metal are mixed with the other support powder, such as solid alumina, silica, titania, zirconia, etc. Moreover, an extra noble metal can be further loaded on the powder, which includes the present alumina particles with a dispersed noble metal only, or can be further loaded on the aforementioned solid support powder.

It is possible to form these powders as a pelletized shape and to use it as a pelletized catalyst. Further, it is possible to coat them on the cellular wall surfaces of a honeycomb-shaped substrate as a coating layer and to use it as a monolithic catalyst. Furthermore, it is possible to use them as a 3-way catalyst, an oxidizing catalyst, an NOₓ selective-reducing catalyst, and so on, as they are. Moreover, it is possible to use them as an NOₓ storage-and-release type catalyst by loading an alkaline-earth metal, etc., thereon. Note that the alkaline-earth metal, etc., can be loaded later, or can be mixed in the dispersion water droplets in the production of the present alumina particles with a dispersed noble metal.

The present invention will be hereinafter described in detail with reference to specific examples.

### EXAMPLE NO. 1

A water phase was prepared by mixing an aluminum nitrate aqueous solution and a platinum dinitrodiammine aqueous solution in predetermined amounts, respectively. The aluminum nitrate aqueous solution was prepared by solving a commercially available aluminum nitrate nona-hydrate in deionized water, and had a concentration of 2 mol/L. The platinum dinitrodiammine aqueous solution had a Pt concentration of 4.616% by mass. The addition amount of Pt was controlled so that it was 0.5 g with respect to 100 g of the generating alumina.

As the organic solvent, a commercially available kerosine was used. As the dispersion agent, a “SUNSOFT No. 818H”, which was made by TAIYO KAGAKU Co., Ltd. was used. The addition amount of the dispersion agent was controlled so as to fall in a range of from 5 to 10% by mass with respect to the kerosine. The kerosine with the dispersion agent added was used as an oil phase, and was mixed with the water phase so that the ratio of the water phase with respect to the oil phase fell in a range of from 40/60 to 70/30 by volume. Specifically, the water phase/the oil phase=from 40/60 to 70/30 by volume. Then, a W/O type emulsion was prepared by stirring the mixture solution with a homogenizer at a revolving speed of from 1,000 to 20,000 rpm for 5 to 30 minutes. Note that, according to the results of observation with an optical microscope, the diameter of the dispersion particles, which were included in the W/O type emulsion, fell in a range of from 1 to 2 μm approximately.

The W/O type emulsion, which was prepared as set forth above, was sprayed by an emulsion burning reactor, which is disclosed in Japanese Unexamined Patent Publication (KOKAI) No. 7-81,905. Then, the oil phase was burned, and at the same time the Al ions, which existed in the water phase, were oxidized. Thus, a powder was synthesized which comprised alumina particles with dispersed Pt.

This synthesis was carried out while controlling the spraying flow quantity of the W/O type emulsion, the flow quantity of air (or oxygen), and the like, so that the sprayed W/O type emulsion was combusted completely, and so that the flame temperature was a constant temperature of about 800° C. The resulting powder was collected with a bag filter, which was disposed at the rear end of a connector tube of the emulsion-burning reactor.

The particles of the resultant collected powder were formed as hollow particles, and exhibited a BET specific surface area of 43 m²/g.

Subsequently, the resultant collected powder was held in an electric furnace. The powder was subjected to a heat treatment, which was carried out at 1,000° C. for 4 hours while flowing a fuel-rich model gas. The fuel-rich model gas was equivalent to a reducing atmosphere whose A/F=14. Thus, alumina particles with dispersed Pt of Example No. 1 were prepared.

The Pt dispersion degrees of the resulting alumina particles with dispersed Pt were measured by the CO adsorption method before and after the heat treatment, respectively. The results are summarized in Table 1 below. Note that, in the CO adsorption method, a nitrogen gas was used in which CO was included in a concentration of 10% by volume.

The resulting alumina particles with dispersed Pt were pressurized by an ordinary-temperature hydrostatic-pressure press (or CIP), and were thereafter pulverized. Then, the pulverized particles were graded as a pelletized shape of from 1.0 to 1.7 mm in diameter. Thus, a pelletized catalyst of Example No. 1 was prepared.

### EXAMPLE NO. 2

The collected powder, which was obtained in the same manner as Example No. 1, was held in a graphite resistor heating furnace while flowing a nitrogen gas, and was subjected to a heat treatment, which was carried out at 960° C. for 4 hours. Thus, alumina particles with dispersed Pt of Example No. 2 were prepared. The Pt dispersion degrees of the resulting alumina particles with dispersed Pt were measured by the CO adsorption method before and after the heat treatment, respectively, in the same fashion as Example No. 1. The results are summarized in Table 1 below.

The alumina particles with dispersed Pt were used to prepare a pelletized catalyst of Example No. 2 in the same manner as Example No. 1.

### EXAMPLE NO. 3

Except that the amount of Pt, which was contained in the water phase, was controlled so that it was 1.25 g with respect to 100 g of the generating alumina, a W/O type emulsion was sprayed and burned in the same fashion as Example No. 1. Thus, a collected powder was obtained. The particles of the resulting powder were formed as hollow particles, and exhibited a BET specific surface area of 44 m²/g.

The collected powder was subjected to a heat treatment in the same manner as Example No. 1. Thus, alumina particles with dispersed Pt of Example No. 3 were prepared. The Pt dispersion degrees of the resulting alumina particles with dispersed Pt were measured by the CO adsorption method before and after the heat treatment, respectively, in the same fashion as Example No. 1. The results are summarized in Table 1 below.

The alumina particles with dispersed Pt were used to prepare a pelletized catalyst of Example No. 3 in the same manner as Example No. 1.

### EXAMPLE NO. 4

Except that a palladium nitrate aqueous solution was used instead of the platinum dinitrodiammine aqueous solution, and that the amount of Pd, which was contained in the water phase, was controlled so that it was 0.67 g with respect to 100 g of the generating alumina, a W/O type emulsion was sprayed and burned in the same fashion as Example No. 1. Note that the palladium nitrate aqueous solution had a Pd concentration of 5.00% by mass and the platinum dinitrodiammine aqueous solution had a Pt concentration of 4.616% by mass. Thus, a collected powder was obtained. The particles of the resulting powder were formed as hollow particles, and exhibited a BET specific surface area of 42 m²/g.

The collected powder was subjected to a heat treatment in the same manner as Example No. 1. Thus, alumina particles with dispersed Pd of Example No. 4 were prepared. The Pd dispersion degrees of the resulting alumina particles with dispersed Pd were measured by the Co adsorption method before and after the heat treatment, respectively, in the same fashion as Example No. 1. The results are summarized in Table 1 below.

The alumina particles with dispersed Pd were used to prepare a pelletized catalyst of Example No. 4 in the same manner as Example No. 1.

### EXAMPLE NO. 5

A water phase was prepared by mixing an aluminum nitrate aqueous solution, a lanthanum nitrate aqueous solution and a platinum dinitrodiammine aqueous solution in predetermined amounts, respectively. The aluminum nitrate aqueous solution was prepared by solving a commercially available aluminum nitrate nona-hydrate in deionized water, and had a concentration of 2 mol/L. The lanthanum nitrate aqueous solution was prepared by solving a commercially available lanthanum nitrate hexa-hydrate in deionized water, and had a concentration of 2 mol/L. The platinum dinitrodiammine aqueous solution had a Pt concentration of 4.616% by mass. The addition amount of La was controlled so that it was 5 mol % with respect to 100 g of the generating Al₂O₃. The addition amount of Pt was controlled so that it was 0.5 g with respect to 100 g of the generating Al₂O₃.

Then, in the same manner as Example No. 1, a W/O type emulsion was prepared, and was sprayed and burned. Thus, a powder was collected. The particles of the resulting powder were formed as hollow particles, and exhibited a BET specific surface area of 48 m²/g.

Subsequently, the resultant collected powder was held in an electric furnace. The powder was subjected to a heat treatment, which was carried out at 1,150° C. for 4 hours while flowing a fuel-rich model gas. The fuel-rich model gas was equivalent to a reducing atmosphere whose A/F=14. Thus, alumina particles with dispersed Pt and with included La of Example No. 5 were prepared. The Pt dispersion degrees of the resulting alumina particles with dispersed Pt and with included La were measured by the CO adsorption method before and after the heat treatment, respectively. The results are summarized in Table 1 below.

The alumina particles with dispersed Pt and with included La were used to prepare a pelletized catalyst of Example No. 5 in the same manner as Example No. 1.

### EXAMPLE NO. 6

Except that a barium nitrate aqueous solution was used instead of the lanthanum nitrate aqueous solution, a W/O type emulsion was prepared, and was sprayed and burned in the same manner as Example No. 5. The barium nitrate aqueous solution had a concentration of 0.1 mol/L. Thus, a powder was collected. The particles of the resulting powder were formed as hollow particles, and exhibited a BET specific surface area of 46 m²/g.

Subsequently, the resultant collected powder was held in an electric furnace. The powder was subjected to a heat treatment, which was carried out at 1,150° C. for 4 hours while flowing a fuel-rich model gas. The fuel-rich model gas was equivalent to a reducing atmosphere whose A/F=14. Thus, alumina particles with dispersed Pt and with included Ba of Example No. 6 were prepared. The Pt dispersion degrees of the resulting alumina particles with dispersed Pt and with included Ba were measured by the CO adsorption method before and after the heat treatment, respectively. The results are summarized in Table 1 below.

The alumina particles with dispersed Pt and with included Ba were used to prepare a pelletized catalyst of Example No. 6 in the same manner as Example No. 1.

### COMPARATIVE EXAMPLE NO. 1

Except that a collected powder, which was obtained in the same fashion as Example No. 1, was used as it was without subjecting it to the heat treatment, alumina particles with dispersed Pt of Comparative Example No. 1 were prepared in the same manner as Example No. 1. The Pt dispersion degrees of the resulting alumina particles with dispersed Pt were measured by the CO adsorption method before and after the heat treatment, respectively, in the same fashion as Example No. 1. The results are summarized in Table 1 below.

The alumina particles with dispersed Pt were used to prepare a pelletized catalyst of Comparative Example No. 1 in the same manner as Example No. 1.

### COMPARATIVE EXAMPLE NO. 2

50 g of a γ-Al₂O₃ powder was added to a predetermined amount of a platinum dinitrodiammine aqueous solution. The platinum dinitrodiammine aqueous solution had a Pt concentration of 4.616% by mass. The γ-Al₂O₃ powder exhibited a BET specific surface area of 180 m²/g. While stirring the mixture on a hot plate, the water content was evaporated. Then, after drying the mixture at 120° for 24 hours, it was subjected to a heat treatment in which it was calcined in air at 500° C. for 1 hour. The Pt dispersion degrees of the resulting Al₂O₃ powder with loaded Pt were measured by the CO adsorption method before and after the heat treatment, respectively, in the same fashion as Example No. 1. The results are summarized in Table 1 below.

The alumina powder with loaded Pt was used to prepare a pelletized catalyst of Comparative Example No. 2 in the same manner as Example No. 1. In the pelletized catalyst of Comparative Example No. 2, the loading amount of Pt was 1.25% by mass with respect to 100% by mass of the γ-Al₂O₃.

### COMPARATIVE EXAMPLE NO. 3

50 g of a γ-Al₂O₃ powder was added to a predetermined amount of a platinum dinitrodiammine aqueous solution. The platinum dinitrodiammine aqueous solution had a Pt concentration of 4.616% by mass. The γ-Al₂O₃ powder exhibited a BET specific surface area of 180 m²/g. While stirring the mixture on a hot plate, the water content was evaporated. Then, after drying the mixture at 120° C. for 24 hours, it was subjected to a heat treatment which was carried out in a fuel-rich model gas in air at 1,000° C. for 4 hours in the same manner as Example No. 1. The Pt dispersion degrees of the resulting Al₂O₃ powder with loaded Pt were measured by the CO adsorption method before and after the heat treatment, respectively, in the same fashion as Example No. 1. The results are summarized in Table 1 below.

The alumina powder with loaded Pt was used to prepare a pelletized catalyst of Comparative Example No. 3 in the same manner as Example No. 1. In the pelletized catalyst of Comparative Example No. 3, the loading amount of Pt was 1.25% by mass with respect to 100% by mass of the γ-Al₂O₃.

### COMPARATIVE EXAMPLE NO. 4

A collected powder, which was obtained in Example No. 3, was used, was held in an electric furnace, and was subjected to a heat treatment, which was carried out in air at 1,000° C. for 4 hours. The Pt dispersion degrees of the resulting Al₂O₃ powder with loaded Pt were measured by the CO adsorption method before and after the heat treatment, respectively, in the same fashion as Example No. 1. The results are summarized in Table 1 below.

The alumina powder with loaded Pt was used to prepare a pelletized catalyst of Comparative Example No. 4 in the same manner as Example No. 1.

### COMPARATIVE EXAMPLE NO. 5

Except that a platinum dinitrodiammine aqueous solution was not mixed, and that only an aluminum nitrate aqueous solution was formed as a water phase, a W/O emulsion was sprayed and burned in the same manner as Example No. 1. Thus, an alumina powder was collected which was composed of hollow particles. The resultant collected powder exhibited a BET specific surface area of 50 m²/g.

50 g of the above-described Al₂O₃ powder was added to a predetermined amount of a platinum dinitrodiammine aqueous solution. The platinum dinitrodiammine aqueous solution had a Pt concentration of 4.616% by mass. While stirring the mixture on a hot plate, the water content was evaporated. Then, after drying the mixture at 120° C. for 24 hours, it was subjected to a heat treatment which was carried out in the same manner as Example No. 1. The Pt dispersion degrees of the resulting Al₂O₃ powder with loaded Pt were measured by the CO adsorption method before and after the heat treatment, respectively, in the same fashion as Example No. 1. The results are summarized in Table 1 below.

The alumina powder with loaded Pt was used to prepare a pelletized catalyst of Comparative Example No. 5 in the same manner as Example No. 1. In the pelletized catalyst of Comparative Example No. 5, the loading amount of Pt was 1.25% by mass with respect to 100% by mass of the γ-Al₂O₃.

<Test and Evaluation>

The respective pelletized catalysts were placed in an ordinary-pressure flow type durability testing apparatus, respectively, and were subjected to a deterioration treatment in which a model gas equivalent to the stoichiometric gas was flowed through the respective catalysts at a flow quantity of 5 L/min. at a gas temperature of 1,000° C. at the inlet of the respective catalysts for 5 hours.

Then, 2.0 g of the respective catalysts, which had undergone the deterioration treatment, were placed in an ordinary-pressure flow type reactor, respectively. A model gas, which was equivalent to the stoichiometric gas, was flowed through the respective catalysts at a flow quantity of 5 L/min. while raising the temperature of the model gas from room temperature to 500° C. at a rate of 20° C. /min. During the increment of the model gas temperature, the conversions of HC and CO were measured substantially continuously, and the temperatures (i.e., T50), at which HC and CO were purified by 50%, were determined, respectively. The results are summarized in Table 1 below.

Note that, regarding the pelletized catalysts of Example No. 1 and Comparative Example No. 1, the T50's before the deterioration treatment were measured similarly. The results are also summarized in Table 1 below.

TABLE 1

| | | | | | | | T50 (° C.) | | T50 (° C.) | |
|---|---|---|---|---|---|---|---|---|---|---|
| | | N.B.A.*¹ | S.S.A.*² | | N.M.D.D.*⁴ (%) | | B.D.T.*⁵ | | A.D.T.*⁶ | |
| | Form | (%) | (m²/g) | H.T.C.*³ | B.H.T.*⁷ | A.H.T.*⁸ | HC | NO | HC | NO |
| Ex. #1 | H. A. with D. Pt*⁹ | 0.50 | 43 | F.R. Gas*¹⁰ & 1,000° C. for 4 hrs. | 3.4 | 10.2 | 387 | 397 | 388 | 396 |
| Ex. #2 | H. A. with D. Pt*⁹ | 0.50 | 43 | N₂ Gas & 960° C. for 4 hrs. | 3.4 | 10.5 | — | — | 389 | 395 |
| Ex. #3 | H. A. with D. Pt*⁹ | 1.25 | 44 | F.R. Gas*¹⁰ & 1,000° C. for 4 hrs. | 6.1 | 12.0 | — | — | 374 | 384 |
| Ex. #4 | H. A. with D. Pd*¹¹ | 0.67 | 42 | F.R. Gas*¹⁰ & 1,000° C. for 4 hrs. | 4.1 | 11.0 | — | — | 390 | 392 |
| Ex. #5 | H. A. with D. Pt | 0.50 | 48 | F.R. Gas*¹⁰ & 1,150° C. for 4 hrs. | 3.8 | 11.1 | — | — | 388 | 395 |
| | & with I. La*¹² | | | | | | | | | |
| Ex. #6 | H. A. with D. Pt | 0.50 | 46 | F.R. Gas*¹⁰ & 1,150° C. for 4 hrs. | 4.0 | 10.5 | — | — | 386 | 394 |
| | & with I. Ba*¹³ | | | | | | | | | |
| Comp. Ex. #1 | H. A. with D. Pt*⁹ | 0.50 | 43 | W/O H. T.*¹⁴ | 3.4 | — | 372 | 384 | 408 | 423 |
| Comp. Ex. #2 | S. A. with L. Pt*¹⁵ | 1.25 | 180 | In Air & 500° C. for 4 hrs. | 47.0 | 48.8 | — | — | 410 | 435 |
| Comp. Ex. #3 | S. A. with L. Pt*¹⁶ | 1.25 | 180 | F.R. Gas*¹⁰ & 1,000° C. for 4 hrs. | 47.0 | 48.5 | — | — | 411 | 432 |
| Comp. Ex. #4 | H. A. with D. Pt*⁹ | 1.25 | 44 | In Air & 1,000° C. for 4 hrs. | 6.1 | 1.0 | — | — | 418 | 434 |
| Comp. Ex. #5 | H. A. with L. Pt*¹⁶ | 1.25 | 50 | F.R. Gas*¹⁰ & 1,000° C. for 4 hrs. | 40.3 | 41.0 | — | — | 402 | 420 |

Note:
(1) “N.B.A.*¹” stands for “Noble Metal Amount”.
(2) “S.S.A.*²” stands for “Specific Surface Area”.
(3) “H.T.C.*³” stands for “Heat Treatment Conditions”.
(4) “N.M.D.D.*⁴” stands for “Noble Metal Dispersion Degree”.
(5) “T50 (° C.) B.D.T.*⁵” stands for “T50 (° C.) Before Deterioration Treatment”.
(6) “T50 (° C.) A.D.T.*⁶” stands for “T50 (° C.) After Deterioration Treatment”.
(7) “B.H.T.*⁷” stands for “Before Heat Treatment”.
(8) “A.H.T.*⁸” stands for “After Heat Treatment”.
(9) “H. A. with D. Pt*⁹” stands for “Hollow Alumina with Dispersed Pt”.
(10) “F. R. Gas*¹⁰” stands for “Fuel-rich Gas”.
(11) “H. A. with D. Pd*¹¹” stands for “Hollow Alumina with Dispersed Pd”.
(12) “H. A. with D. Pt & with I. La*¹²” stands for “Hollow Alumina with Dispersed Pt and with Included La”.
(13) “H. A. with D. Pt & with I. Ba*¹³” stands for “Hollow Alumina with Dispersed Pt and with Included Ba”.
(14) “W/O H. T.*¹⁴” stands for “Without Heat Treatment”.
(15) “S. A. with L. Pt*¹⁵” stands for “Solid Alumina with Loaded Pt”.
(16) “H. A. with L. Pt*¹⁶” stands for “Hollow Alumina with Loaded Pt”.

According to Table 1, it is understood that, by comparing Example No. 1 with comparative Example No. 1, the purifying performance after the deterioration treatment was improved markedly by the heat treatment which was carried out in the fuel-rich gas. Moreover, since the noble metal dispersion degree was enlarged remarkably in Example No. 1 after the heat treatment, it is apparent that Pt was exposed greatly by the heat treatment. Thus, it is appreciated that the purifying performance after the deterioration treatment was enhanced.

Further, by comparing Example Nos. 1 through 3 with Comparative Example No. 4, the aforementioned advantage could be effected when the heat treatment was carried out in a non-oxidizing atmosphere. It is evident, however, that the noble metal dispersion degree was lowered adversely and the purifying performance after the deterioration treatment was degraded by the heat treatment which was carried out in air.

Furthermore, by comparing Example No. 3 with Comparative Example No. 3, although the solid alumina was upgraded to a certain extent in terms of the noble metal dispersion degree by the heat treatment which was carried out in a non-oxidizing atmosphere, it exhibited low purifying activities after the deterioration treatment. However, it is seen that, in the case of the hollow alumina particles in Example No. 3, the advantage resulting from the heat treatment was effected considerably greatly and thereby the purifying performance after the deterioration treatment was enhanced markedly.

Moreover, it is apparent that, since Example No. 5 and 6 further included La or Ba, they exhibited high noble metal dispersion degrees after the heat treatment, which was carried out at a temperature as high as 1,150° C., and that they were remarkably good in terms of the heat resistance.

Having now fully described the present invention, it will be apparent to one of ordinary skill in the art that many changes and modifications can be made thereto without departing from the spirit or scope of the present invention as set forth herein including the appended claims.

What is claimed is:

1. Alumina particles with a dispersed noble metal, the alumina particles being hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method.

2. The alumina particles with a dispersed noble metal according to claim 1 further comprising at least one member selected from the group consisting of rare-earth elements and alkaline-earth metals.

3. The alumina particles with a dispersed noble metal according to claim 1 having a shell thickness 100 nm or less.

4. The alumina particles with a dispersed noble metal according to claim 1 having an outside diameter falling in a range of from 50 nm to 5 μm.

5. The alumina particles with a dispersed noble metal according to claim 1 having an inside diameter and an outside diameter and having a ratio of the inside diameter with respect to the outside diameter falling in a range of from 0.5 to 0.99.

6. The alumina particles with a dispersed noble metal according to claim 1 having a specific surface area of 30 m²/g or more.

7. The alumina particles with a dispersed noble metal according to claim 1, wherein the alumina has a crystalline grain boundary in at least a part thereof and is crystallized therein.

8. The alumina particles with a dispersed noble metal according to claim 2, wherein the member is included in an amount of from 1 to 10% by mol with respect to the alumina.

9. The alumina particles with a dispersed noble metal according to claim 2, wherein the rare-earth element is at least one element selected from the group consisting of La, Ce, Yb, Nd and Sm.

10. The alumina particles with a dispersed noble metal according to claim 2, wherein the alkaline-earth metal is at least one element selected from the group consisting of Ba and Mg.

11. The alumina particles with a dispersed noble metal according to claim 1, wherein the noble metal is at least one element selected from the group consisting of Pt, Rh, Pd, Ir, Ru.

12. The alumina particles with a dispersed noble metal according to claim 1 including the noble metal in an amount of from 0.1 to 5% by mass with respect to the alumina matrix.

13. A process for producing the alumina particles with a dispersed noble metal, comprising the steps of:
preparing a W/O type emulsion, which is formed by dispersing an aqueous solution in an organic solvent, the aqueous solution comprising aluminum element as a major component and at least one noble metal;
spraying and burning the W/O type emulsion, thereby forming hollow particles; and
heat-treating the hollow particles in a non-oxidizing atmosphere at a temperature of from 950° C. or more to 1,050° C. or less, thereby preparing alumina particles being hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method.

14. The production process according to claim 18, wherein the W/O type emulsion includes dispersion water droplets whose diameter falls in a range of from 100 nm to 10 μm.

15. The production process according to claim 18, wherein said step of spraying and burning the W/O type emulsion is carried out at a burning temperature of 1,000° C. or less.

16. The production process according to claim 18, wherein the W/o type emulsion includes dispersion water droplets having a metallic concentration falling in a range of from 0.2 to 2.4 mol/L by metallic conversion.

17. The production process according to claim 18, wherein said step of heat-treating the hollow particles is carried out for 0.1 to 10 hours.

18. A process for producing the alumina particles with a dispersed noble metal, comprising the steps of:
preparing a W/O type emulsion, which is formed by dispersing an aqueous solution in an organic solvent, the aqueous solution comprising aluminum element as a major component, at least one noble metal and at least one member selected from the group consisting of rare-earth elements and alkaline-earth metals;
spraying and burning the W/O type emulsion, thereby forming hollow particles; and
heat-treating the hollow particles in a non-oxidizing atmosphere at a temperature of from 950° C. or more to 1,200° C. or less, thereby preparing alumina particles being hollow-structured alumina particles which comprise alumina as a major component of the matrix, in which at least one noble metal is dispersed in the alumina matrix and/or on the surface of the alumina particles with a dispersion degree of 10% or more when being measured by the CO adsorption method, and which further comprise at least one member selected from the group consisting of rare-earth elements and alkaline-earth metals.

19. The production process according to claim 26, wherein the W/O type emulsion includes dispersion water droplets whose diameter falls in a range of from 100 nm to 10 μm.

20. The production process according to claim 26, wherein said step of spraying and burning the W/O type emulsion is carried out at a burning temperature of 1,000° C. or less.

21. The production process according to claim 26, wherein the W/O type emulsion includes dispersion water droplets having a metallic concentration falling in a range of from 0.2 to 2.4 mol/L by metallic conversion.

22. The production process according to claim 26, wherein said step of heat-treating the hollow particles is carried out for 0.1 to 10 hours.

23. A catalyst for purifying an exhaust gas, comprising: alumina particles with a dispersed noble metal, the alumina particles being hollow-structured alumina particles which comprise alumina as a major component of the matrix, and in which at least one noble metal is dispersed in the alumina matrix and/or on the surface of the alumina particles with a dispersion degree of 10% or more when being measured by the CO adsorption method.
